(19) United States
(12) Patent Application Publication
(10) Pub. No.: US 2014/0335289 A1
(43) Pub. Date: Nov. 13, 2014

(54) METHOD FOR PRODUCING OPTICAL FILM, OPTICAL FILM, POLARIZING PLATE AND LIQUID CRYSTAL DISPLAY DEVICE

(71) Applicant: Konica Minolta, Inc., Tokyo (JP)

(72) Inventors: Masataka Takimoto, Tokyo (JP); Kenzo Kasahara, Tokyo (JP); Akira Shimizu, Hyogo (JP); Mutsumi Kasahara, Tokyo (JP)

(21) Appl. No.: 14/361,183

(22) PCT Filed: Nov. 30, 2012
(86) PCT No.: PCT/JP2012/007708

§ 371 Date: May 28, 2014

(30) Foreign Application Priority Data
Dec. 1, 2011 (JP) 2011-263635

(51) Int. Cl. G02B 1/10; C08L 39/04; G02F 1/1335; B29C 47/00; G02B 5/30

(52) U.S. Cl. CPC G02B 1/10; B29C 47/0004; G02B 5/305; G02F 1/133528; C08L 39/04; B29L 2011/00
USPC 428/1.33; 264/1.1; 428/522; 524/40

(57) ABSTRACT

A method for producing an optical film of the present invention includes: (1) a step for obtaining a (meth)acrylic resin by copolymerizing methyl methacrylate and a copolymerizable monomer containing an acryloyl morpholine in the presence of a polymerization initiator and a chain transfer agent; and (2) a step for obtaining an optical film by melt extruding a resin composition that contains the thus-obtained (meth)acrylic resin and a cellulose ester resin at a (meth)acrylic resin:cellulose ester resin ratio of from 95:5 to 30:70. The (meth)acrylic resin obtained in step (1) is characterized in that: (a) the weight average molecular weight (Mw) thereof is from 2.0×10⁴ to 5.0×10⁵; (b) the total amount of the remaining methyl methacrylate and the remaining copolymerizable monomer is 0.05-1% by mass; (c) the amount of the remaining polymerization initiator is 0.01-0.5% by mass; and (d) the amount of the remaining chain transfer agent is 0.01-0.5% by mass.

### TECHNICAL FIELD

The present invention relates to a method for producing an optical film, an optical film, a polarizing plate, and a liquid crystal display device.

### BACKGROUND ART

Liquid crystal display devices are widely used as liquid crystal displays for televisions, personal computers, and other devices. The liquid crystal display device typically has a liquid crystal cell, a pair of polarizing plates between which the liquid crystal cell is interposed, and a backlight. The polarizing plate typically has a polarizer and a pair of protective films between which the polarizer is interposed.

A cellulose triacetate film is typically used as the protective film because it has high heat resistance. However, the cellulose triacetate film is subjected to dimensional changes under a high-humidity condition and therefore has the drawback of being subjected to changes in optical performance.

Optical films have therefore been proposed which are obtained by melt-extruding a resin composition containing a cellulose ester resin having high heat resistance and a (meth)acrylic resin having high moisture resistance (see, e.g., PTLs 1 and 2).

### CITATION LIST

### Patent Literature

### PTL 1

International Publication No. WO 2009/130969

### PTL 2

Japanese Patent Application Laid-Open No. 2009-271510

### SUMMARY OF INVENTION

### Technical Problem

However, the optical films obtained by melt-extrusion of resin compositions containing (meth)acrylic resin and cellulose ester resin have the drawback of being prone to exhibit high haze due to coloring and/or presence of gel-like matter formed in the film.

A possible main cause of coloring and gel-like matter is residual components contained in the (meth)acrylic resin. That is, since a (meth)acrylic resin is typically obtained by polymerizing a monomer such as methyl methacrylate in the presence of a polymerization initiator, a chain transfer agent and the like, the (meth)acrylic resin may contain residual components such as an unreacted monomer, polymerization initiator and chain transfer agent. It is considered that these residual components react with the cellulose ester resin to form gel-like matter and/or decompose the cellulose ester resin to cause coloring, which in turn results in the generation of gel-like matter and coloring in the resultant film.

The present invention has been made in view of the above circumstances. An object of the present invention is to provide a method for producing an optical film having a reduced haze by limiting coloring of film and formation of gel-like matter.

### Solution to Problem

[1] A method for producing an optical film including:

(1) subjecting methyl methacrylate and a copolymerizable monomer containing acryloyl morpholine to a copolymerization reaction in the presence of a polymerization initiator and a chain transfer agent to afford a (meth)acrylic resin; and

(2) melt-extruding a resin composition containing the obtained (meth)acrylic resin and a cellulose ester resin at a (meth)acrylic resin:cellulose ester resin ratio of 95:5 to 30:70 to afford an optical film, in which the (meth)acrylic resin obtained in (1) satisfies the following requirements (a), (b), (c), and (d):

(a) a weight average molecular weight Mw is 2.0×10⁴ to 5.0×10⁵;

(b) a total amount of the residual methyl methacrylate and copolymerizable monomer is 0.05 to 1% by weight;

(c) an amount of the residual polymerization initiator is 0.01 to 0.5% by weight; and

(d) an amount of the residual chain transfer agent is 0.01 to 0.5% by weight.

[2] The method for producing an optical film according to [1], in which a proportion of a constitutional unit derived from methyl methacrylate in the obtained (meth)acrylic resin is 50 to 99 mol %; and a proportion of a constitutional unit derived from the copolymerizable monomer containing acryloyl morpholine is 1 to 50 mol %.

[3] The method for producing an optical film according to [1] or [2], in which the copolymerization reaction is a bulk polymerization reaction.

[4] The method for producing an optical film according to any one of [1] to [3], in which the cellulose ester resin has a degree of acyl substitution of 2.0 to 3.0 and a degree of C₃₋₇ acyl substitution of 1.2 to 3.0.

[5] The method for producing an optical film according to any one of [1] to [4], in which the cellulose ester resin has a weight average molecular weight Mw of 7.5×10⁴ to 3.0×10⁵.

[6] An optical film obtained by the method according to any one of [1] to [5], in which the optical film has a haze of less than 1.0%.

[7] A polarizing plate including: a polarizer; and the optical film according to [6] disposed on at least one surface of the polarizer.

[8] A liquid crystal display device including: a liquid crystal cell; and the polarizing plate according to [7] disposed on at least one surface of the liquid crystal cell.

### Advantageous Effects of Invention

The present invention can provide a method for producing an optical film having a reduced haze by limiting the coloring of the film and formation of gel-like matter.

### BRIEF DESCRIPTION OF DRAWINGS

FIG. 1 illustrates an example of a method for synthesizing a (meth)acrylic resin;

FIG. 2 schematically illustrates an example of a film forming apparatus; and

FIG. 3 schematically illustrates a basic constitution of an embodiment of a liquid crystal display device according to the present invention.

### DESCRIPTION OF EMBODIMENTS

### 1. Method for Producing Optical Film

A method for producing an optical film of the present invention includes: (1) subjecting methyl methacrylate and a copolymerizable monomer containing acryloyl morpholine to a copolymerization reaction to afford a (meth)acrylic resin; and (2) melt-extruding a resin composition containing the obtained (meth)acrylic resin and a cellulose ester resin to afford the optical film.

Step (1)

Methyl methacrylate and a copolymerizable monomer containing acryloyl morpholine are subjected to a copolymerization reaction in the presence of a radical polymerization initiator and a chain transfer agent to afford a (meth)acrylic resin.

Acryloyl morpholine may be used alone as the copolymerizable monomer containing acryloyl morpholine. The copolymerizable monomer may contain acryloyl morpholine and other copolymerizable monomer. Acryloyl morpholine is preferably used alone as the copolymerizable monomer in order to enhance the compatibility of a (meth)acrylic resin with a cellulose ester resin.

Examples of the copolymerizable monomer other than acryloyl morpholine include alkyl methacrylate having a C₂₋₁₈ alkyl moiety; alkyl acrylate having a C₁₋₁₈ alkyl moiety; unsaturated group-containing dicarboxylic acids such as α,β-unsaturated acids, e.g., acrylic acid and methacrylic acid, maleic acid, fumaric acid, and itaconic acid; aromatic vinyl compounds such as styrene and α-methylstyrene, α,β-unsaturated nitriles such as acrylonitrile and methacrylonitrile, maleic anhydride, maleimide, N-substituted maleimide, and glutaric anhydride. The copolymerizable monomers other than acryloyl morpholine may be used alone or as a mixture of two or more types.

The charging amounts of methyl methacrylate and a copolymerizable monomer containing acryloyl morpholine may be such that the proportions of a constitutional unit derived from methyl methacrylate and a constitutional unit derived from the copolymerizable monomer containing acryloyl morpholine in the resultant (meth)acrylic resin may be within the ranges to be described below. That is, a methyl methacrylate:copolymerizable monomer containing acryloyl morpholine ratio is preferably 30:70 to 99:1, and more preferably 50:50 to 99:1.

Examples of the radical polymerization initiator include organic peroxides such as t-butyl hydroperoxide, cumene hydroperoxide, benzoyl peroxide, and t-butylperoxy-2-ethylhexanoate; persulfates such as potassium persulfate and ammonium persulfate; azo compounds such as 2,2′-azobis(2-methylpropionitrile) (AIBN) and azobis-2,4-dimethylvaleronitrile; redox-based initiators containing organic peroxides with reducing agents; and redox-based initiators containing persulfates in combination with reducing agents. The radical polymerization initiator may be used alone or as a mixture of two or more types.

The charging amount of the radical polymerization initiator may be about 0.01 to 1% by weight based on the total amount of monomer components.

Examples of the chain transfer agent include a C₃₋₁₈ alkyl mercaptan. Examples of the alkyl mercaptan include n-octyl mercaptan and dodecyl mercaptan.

The charging amount of the chain transfer agent may be about 0.05 to 1% by weight based on the total amount of the monomer components.

The copolymerization of methyl methacrylate with the copolymerizable monomer containing acryloyl morpholine may be any of suspension polymerization, emulsion polymerization, solution polymerization, and bulk polymerization. Among these, bulk polymerization is preferable because this process uses no solvent during polymerization, so that separation of the resultant polymer from the solvent is not required and contamination of the resultant polymer with an emulsifier, a dispersant or the like is less frequent.

Polymerization temperature in the suspension polymerization or the emulsion polymerization may be 30 to 100° C.; and a polymerization temperature in the bulk polymerization may be preferably 80 to 300° C. Polymerization reaction in the bulk polymerization may be performed in a polymerization reactor, a heater, or a devolatilization extruder as described below. Polymerization time may be 1 to 10 hours, for example.

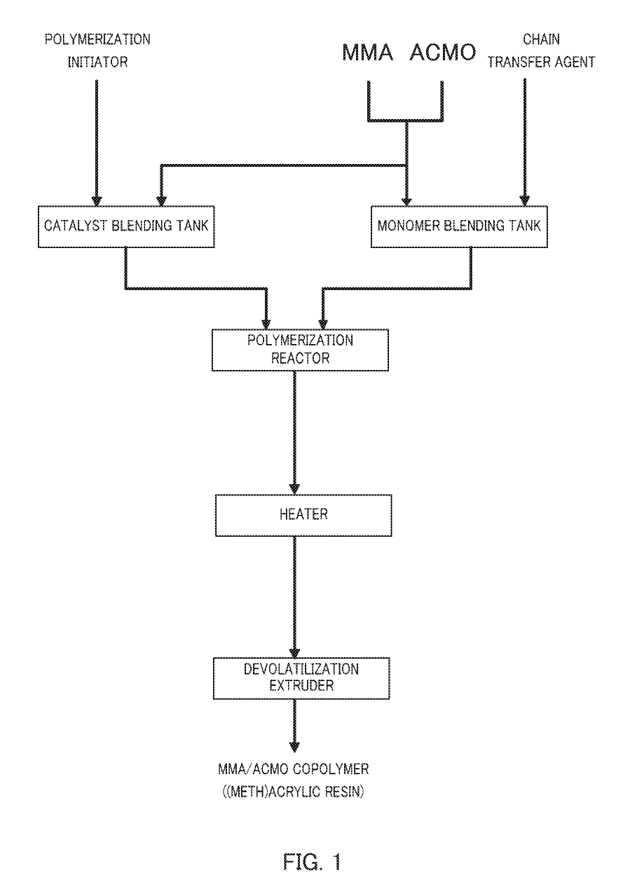

FIG. 1 illustrates an example of a method for synthesizing a (meth)acrylic resin. FIG. 1 is an example in which methyl methacrylate (MMA) and acryloyl morpholine (ACMO) are subjected to bulk polymerization.

As shown in FIG. 1, methyl methacrylate (MMA) and acryloyl morpholine (ACMO), which are raw material monomers, and a polymerization initiator (catalyst) are mixed in a catalyst blending tank to afford a catalyst liquid.

On the other hand, methyl methacrylate (MMA) and acryloyl morpholine (ACMO) which are raw material monomers, and a chain transfer agent are mixed in a monomer blending tank to afford a monomer mixed liquid.

The obtained catalyst liquid and monomer mixed liquid are mixed in the polymerization reactor to polymerize methyl methacrylate (MMA) and acryloyl morpholine (ACMO). A liquid polymer composition is thereby obtained. A polymerization temperature in the polymerization reactor may be 80 to 200° C., and preferably 80 to 180° C. In order to produce a polymer composition (liquid polymerization composition) having flowability, the polymerization reaction of methyl methacrylate (MMA) and acryloyl morpholine (ACMO) in the polymerization reactor is preferably performed so that the average polymerization rate of the resultant polymerization composition is 80% by weight or less; and in order to increase the reaction efficiency, the polymerization reaction is preferably performed so that the average polymerization rate of the resultant polymerization composition is 10% by weight or more. The average polymerization rate means a ratio (mass ratio) of the polymer contained in the liquid polymer composition.

The obtained liquid polymer composition is supplied to the devolatilization extruder while the liquid polymer composition is heated by the heater. The heater is heat retention means for sending the liquid polymer composition to the devolatilization extruder without lowering the temperature of the liquid polymer composition. Heating temperature in the heater may be preferably 150 to 250° C. Then, a volatile component (containing an unreacted monomer or the like) of the obtained polymer composition is volatilized from a vent, and removed while the polymer composition is melt-kneaded in the devolatilization extruder. Melting temperature may be preferably 200 to 300° C. After the melt-kneaded melt is extruded, the melt is water-cooled and cut to afford pellets of the (meth)acrylic resin.

The proportion of the constitutional unit derived from methyl methacrylate in the resultant (meth)acrylic resin is preferably 30 to 99 mol %, more preferably 50 to 99 mol %, and still more preferably 50 to 95 mol %. When the proportion of the constitutional unit derived from methyl methacrylate is less than 30 mol %, the resultant film containing (meth)acrylic resin has low flexibility and tends to be brittle. On the other hand, when the proportion of the constitutional unit derived from methyl methacrylate is more than 99 mol %, the resultant (meth)acrylic resin may have insufficient heat resistance.

The proportion of the constitutional unit derived from the copolymerizable monomer containing acryloyl morpholine in the (meth)acrylic resin is preferably 1 to 70 mol %, more preferably 1 to 50 mol %, and still more preferably 5 to 30 mol %. In order to enhance the compatibility of the (meth)acrylic resin with the cellulose ester resin, the constitutional unit derived from the copolymerizable monomer containing acryloyl morpholine preferably contains only the constitutional unit derived from acryloyl morpholine.

The (meth)acrylic resin; particularly the (meth)acrylic resin obtained by the bulk polymerization tends to contain residual components such as unreacted monomers (methyl methacrylate and copolymerizable monomer), an unreacted radical polymerization initiator, and an unreacted chain transfer agent. When the (meth)acrylic resin containing the residual components and the cellulose ester resin are melt-kneaded, coloring and gel-like matter are likely to occur.

Although the cause of gel-like matter and coloring is not necessarily clear, it is considered as follows. Gel-like matter is considered to be formed by the chemical or physical action between a polymer produced by polymerization of unreacted monomer and the cellulose ester resin. Because the retention time of the molten resin tends to be long in a filtration filter for removing the foreign substances in the molten resin, gel-like matter is likely to be formed. Furthermore, a part of the polymerization initiator and the chain transfer agent are considered to decompose the cellulose ester resin and easily causes coloring. In view of the foregoing, it is considered that the resultant film is prone to coloring and gel-like matter, resulting in high haze. Specifically, the unreacted monomer and the radical polymerization initiator of the residual components tend to form gel-like matter during melt-kneading; and the unreacted chain transfer agent tends to cause coloring of the resultant film.

Then, it is considered to be effective to reduce the residual components contained in the (meth)acrylic resin to a specific value or less. However, when the contents of the residual components are reduced, the molecular weight of the resultant (meth)acrylic resin tends to be high. A melt of (meth)acrylic resin having a large molecular weight exhibits high viscosity. Therefore, not only the (meth)acrylic resin cannot be easily melt-extruded, but the film obtained by melt-kneading the mixture of the (meth)acrylic resin and cellulose ester resin tends to have gel-like matter.

That is, in order to limit the coloring of the resultant optical film and the formation of gel-like matter in the film, it is important to balance the amount and the molecular weight of the residual components contained in the (meth)acrylic resin. That is, it is preferable that the resultant (meth)acrylic resin simultaneously satisfies the following requirements (a) to (d):

(a) a weight average molecular weight Mw is 2.0×10⁴ to 5.0×10⁵;

(b) the total amount of the residual methyl methacrylate and copolymerizable monomer is 0.05 to 1% by weight;

(c) the amount of the residual polymerization initiator is 0.01 to 0.5% by weight; and

(d) the amount of the residual chain transfer agent is 0.01 to 0.5% by weight.

Requirement (a) When the weight average molecular weight Mw of the (meth)acrylic resin is more than 5.0×10⁵, not only the (meth)acrylic resin is not easily melt-extruded, but gel-like matter is likely to be formed during melt-kneading.

The weight average molecular weight Mw of the (meth)acrylic resin can be adjusted by the charging amounts of the radical polymerization initiator and chain transfer agent, the polymerization temperature and the polymerization time in the polymerization reactor, the heating temperature in the heater, the melting temperature in the devolatilization extruder, and the like. For example, in order to decrease the weight average molecular weight Mw of the (meth)acrylic resin, the charging amounts of the polymerization initiator and chain transfer agent or the like may be increased; the polymerization temperature in the polymerization reactor and the heating temperature in the heater may be increased; and the polymerization time in the polymerization reactor may be shortened.

The weight average molecular weight Mw of the (meth)acrylic resin can be measured by gel permeation chromatography. Measurement conditions can be as follows: Solvent: Methylene chloride

Column: Shodex K806, K805, K803G (manufactured by Showa Denko KK. Three columns were used in connection.)
Column temperature: 25° C.
Sample concentration: 0.1% by weight
Detector: RI Model 504 (manufactured by GL Sciences Inc.)
Pump: L6000 (manufactured by Hitachi Ltd.)
Flow rate: 1.0 ml/min
Calibration curve: A calibration curve based on 13 samples of Mw=2,800,000 to 500 TSK standard polystyrene (manufactured by Tosoh Corporation). It is preferred that the molecular weights of the 13 samples are approximately equally spaced.

Requirement (b)

The amount of the unreacted monomer remaining in the (meth)acrylic resin is preferably 1% by weight or less, and more preferably 0.5% by weight or less. When the amount of the residual unreacted monomer is more than 1% by weight, gel-like matter is likely to be formed in the film obtained by melt-kneading the mixture of the (meth)acrylic resin and the cellulose ester resin. On the other hand, the amount of the residual unreacted monomer is preferably 0.05% by weight or more, and more preferably 0.1% by weight or more. When the amount of the residual unreacted monomer is less than 0.05% by weight, the flexibility of the film obtained by melt-kneading the mixture of the (meth)acrylic resin and the cellulose ester resin tends to decrease.

The amount of the residual unreacted monomer can be adjusted by the polymerization temperature and the polymerization time in the polymerization reactor, the heating temperature in the heater, the melting temperature in the devolatilization extruder, the amount of the volatile component (containing the unreacted monomer) discharged from the vent of the devolatilization extruder, and the like. In order to decrease the amount of the residual unreacted monomer, for example, the polymerization time in the polymerization reactor may be lengthened; or the amount of the volatile component discharged from the vent of the devolatilization extruder may be increased.

Requirement (c)

The amount of the unreacted radical polymerization initiator remaining in the (meth)acrylic resin is preferably 0.5% by weight or less, and more preferably 0.1% by weight or less. When the amount of the residual radical polymerization initiator is more than 0.5% by weight, the coloring and the gel-like matter, particularly, gel-like matter is likely to be formed in the film obtained by melt-kneading the mixture of the (meth)acrylic resin and cellulose ester resin. On the other hand, the amount of the residual radical polymerization initiator is preferably 0.01% by weight or more. When the amount of the residual radical polymerization initiator is less than 0.01% by weight, the flexibility of the film obtained by melt-kneading the mixture of the (meth)acrylic resin and cellulose ester resin tends to decrease.

Requirement (d)

The amount of the unreacted chain transfer agent remaining in the (meth)acrylic resin is preferably 0.5% by weight or less, and more preferably 0.1% by weight or less. When the amount of the residual chain transfer agent is more than 0.5% by weight, coloring tends to occur in the film obtained by melt-kneading the mixture of the (meth)acrylic resin and cellulose ester resin. On the other hand, the amount of the residual chain transfer agent is preferably 0.01% by weight or more. When the content of the unreacted chain transfer agent is less than 0.01% by weight, the flexibility of the film obtained by melt-kneading the mixture of the (meth)acrylic resin and cellulose ester resin tends to decrease.

The amount of the radical polymerization initiator or chain transfer agent remaining in the (meth)acrylic resin can be adjusted by the charging amount of the radical polymerization initiator or chain transfer agent, the polymerization temperature and the polymerization time in the polymerization reactor, the heating temperature in the heater, and the melting temperature in the devolatilization extruder, and the like. For example, in order to decrease the amount of the residual radical polymerization initiator or chain transfer agent, the charging amounts thereof may be decreased; the polymerization temperature in the polymerization reactor and the heating temperature in the heater may be increased; and the polymerization time in the polymerization reactor may be lengthened.

The amount of the residual components contained in the (meth)acrylic resin can be measured by the following method.

(1) 0.1 g of the (meth)acrylic resin is dissolved in acetone of 2 mL and subjected to an ultrasonic treatment for 30 minutes. 50 ppm of ethylene glycol monomethyl ether as an internal standard component is added to the solution, and the solution is then made up to 10 mL with hexane to prepare a sample solution.

(2) The amounts (% by weight) of the monomer, polymerization initiator, and chain transfer agent which are contained in the sample solution are measured by GC/MS. A measuring instrument and measurement conditions for GC/MS can be as follows.

Instrument: HP 6890GC/HP5973MSD (manufactured by Hewlett-Packard Co.)
Column: DB-624 (0.25 mmi.d.×30 ML.) manufactured by J&W
Oven Program: 40° C. (3 min)-20° C./min-230° C. (8 min)

### Inj: 160° C.

### AUX: 250° C.

A preferable procedure for simultaneously satisfying the requirements (a) to (d) includes (i) a step of setting the weight average molecular weight Mw of the (meth)acrylic resin to be targeted, (ii) a step of setting the amount of the radical polymerization initiator accordingly, and (iii) a step of adjusting the polymerization temperature and the polymerization time or the like so that the residual amount of the unreacted monomer, polymerization initiator or chain transfer agent or the like is within a predetermined range (the above requirements (b) to (d) are satisfied).

In order to simultaneously satisfy the requirements (a) to (d), two or more conditions of the charging amount of the radical polymerization initiator or chain transfer agent, the polymerization temperature and the polymerization time in the polymerization reactor, the heating temperature in the heater, the melting temperature, the amount of a volatile matter discharged in the devolatilization extruder, and the like may be simultaneously adjusted. For example, when only the amount of the residual unreacted monomers is to be reduced, it only suffices to increase the amount of the volatile matter discharged in the devolatilization extruder. However, when the amount of the volatile matter discharged in the devolatilization extruder is increased, the molecular weight of the (meth)acrylic resin is also decreased. Therefore, the polymerization temperature may be further decreased or the polymerization time may be lengthened to prevent the decrease in the molecular weight of the (meth)acrylic resin.

In order to simultaneously satisfy the requirements (a) to (d), a condition in which the amount of radical generation in a polymerization reaction process is increased is also effective. This is because the radical polymerization initiator and the chain transfer agent can be consumed (residual radical polymerization initiator and chain transfer agent can be decreased) without excessively increasing the molecular weight when the amount of radical generation is increased in the polymerization reaction process. That is, the polymerization temperature in the polymerization reactor and the heating temperature in the heater are increased, and thereby the molecular weight of the (meth)acrylic resin of (a) can be set to a specific value or less, and the content of the residual components of the (meth)acrylic resin of (b) to (d) can also be set to a specific value or less.

The amounts of the residual monomer, polymerization initiator, and chain transfer agent may be finely adjusted by purifying (for example, reprecipitating) the obtained resin.

The (meth)acrylic resins may be used alone or as a mixture of two or more types. Examples of (meth)acrylic resins other than the (meth)acrylic resins described above include polymethyl methacrylate (PMMA).

Step (2)

The resin composition containing the (meth)acrylic resin obtained in the step (1) and the cellulose ester resin is melt-extruded to afford an optical film.

Resin Composition

The resin composition contains the (meth)acrylic resin obtained in the step (1), and a cellulose ester resin.

The cellulose ester resin preferably has a total degree (Dall) of acyl substitution of 2.0 to 3.0, and more preferably 2.5 to 3.0.

The acyl group of the cellulose ester resin may be an aliphatic acyl group or an aromatic acyl group. However, the acyl group is preferably an aliphatic acyl group. One or two or more different acyl groups may be contained in the cellulose ester resin.

In particular, in order to improve the compatibility of the cellulose ester resin with the (meth)acrylic resin, the degree of C₃₋₇ acyl substitution is preferably 1.2 to 3.0, and more preferably 2.0 to 3.0. This is because the cellulose ester resin containing a specific amount of C₃₋₇ acyl group exhibits higher hydrophobicity than cellulose ester resins containing the same amount of acetyl group and is therefore more compatible with (meth)acrylic resin. Examples of the C₃₋₇ acyl group include propionyl group and butyryl group, with propionyl group being preferable.

The degree of acyl substitution can be measured according to ASTM-D-817-96.

Examples of the cellulose ester resin include cellulose acetate, cellulose propionate, cellulose acetate propionate, and cellulose acetate butylate, with cellulose acetate propionate being preferable.

From the viewpoint of improving the compatibility with (meth)acrylic resin, the weight average molecular weight Mw of the cellulose ester resin is preferably 7.5×10⁴ or more, more preferably in the range of 7.5×10⁴ to 3.0×10⁵, still more preferably in the range of 1.4×10⁵ to 2.4×10⁵, and particularly preferably in the range of 1.6×10⁵ to 2.4×10⁵. When the weight average molecular weight Mw is less than 7.5×10⁵, the resultant optical film may have low flexibility (brittle) and insufficient heat resistance. On the other hand, when the weight average molecular weight Mw is more than 3.0×10⁵, not only a melt has a high viscosity and is not easily melt-extruded, but the cellulose ester resin has low compatibility with the (meth)acrylic resin and the resultant optical film tends to have an increased haze.

The weight average molecular weight Mw of the cellulose ester resin can be measured by gel permeation chromatography (GPC). Measurement conditions can be as follows:

Solvent: Methylene chloride
Column: Shodex K806, K805, K803G (manufactured by Showa Denko KK). Three columns were used in connection.
Column temperature: 25° C.
Sample concentration: 0.1% by weight
Detector: RI Model 504 (manufactured by GL Sciences Inc.)
Pump: L6000 (manufactured by Hitachi Ltd.)
Flow rate: 1.0 ml/min
Calibration curve: A calibration curve based on 13 samples of Mw=1.0×10⁶ to 5.0×10² TSK standard polystyrene (manufactured by Tosoh Corporation). It is preferred that the molecular weights of the 13 samples be approximately equally spaced.

A cellulose ester can be synthesized by any of the methods known in the art. Specifically, cellulose, and an organic acid or anhydride thereof which contains at least acetic acid or anhydride thereof and has carbon atoms of 3 or more are subjected to an esterification reaction in the presence of a catalyst, to synthesize a cellulose triester compound. The cellulose triester is then hydrolyzed to synthesize a cellulose ester resin having a desired degree of acyl substitution. The obtained cellulose ester resin is filtrated, precipitated, washed with water, dehydrated and dried (see a method described in Japanese Patent Application Laid-Open No. 10-45804).

Cotton linter, wood pulp (derived from softwood pulp, derived from hardwood pulp), kenaf or the like can be used for the cellulose as the raw material, for example. The celluloses as the raw material may be used alone or as a mixture of two or more types.

The content ratio of the (meth)acrylic resin to the cellulose ester resin in the resin composition is preferably 95:5 to 30:70, and more preferably 70:30 to 60:40, in a mass ratio. When the proportion of the (meth)acrylic resin is more than 95% by weight, sufficient characteristics of the cellulose ester resin cannot be easily obtained. On the other hand, when the proportion of the (meth)acrylic resin is less than 30% by weight, the resultant film tends to have high brittleness and large photoelastic coefficient.

The above resin composition may further contain optional components such as an ultraviolet absorber, an antioxidant, a plasticizer, a phase difference controlling agent, and fine particles if needed in addition to the (meth)acrylic resin and the cellulose ester resin.

Ultraviolet Absorber

The ultraviolet absorber is a compound which absorbs ultraviolet rays having a wavelength of 400 nm or less. The ultraviolet absorber is a compound which preferably has a transmittance of 10% or less at a wavelength of 370 nm, more preferably 5% or less, and still more preferably 2% or less.

The light transmittance of the ultraviolet absorber can be measured by measuring a solution containing the ultraviolet absorber dissolved in a solvent (e.g., dichloromethane or toluene) with the common method using a spectrophotometer. Spectrophotometer UVIDFC-610 manufactured by Shimadzu Corp., self-recording spectrophotometer model 330, self-recording spectrophotometer model U-3210, self-recording spectrophotometer model U-3410 and self-recording spectrophotometer model U-4000 manufactured by Hitachi Corp., or the like can be used as the spectrophotometer.

The ultraviolet absorber may be an oxybenzophenone-based compound, a benzotriazole-based compound, a salicylate-based compound, a benzophenone-based compound, a cyanoacrylate-based compound, a triazine-based compound, a nickel complex salt-based compound, inorganic powder, or the like. In order not to impair the transparency of the resultant film, the ultraviolet absorber is preferably the benzotriazole-based ultraviolet absorber and the benzophenone-based ultraviolet absorber, and more preferably the benzotriazole-based ultraviolet absorber.

Specific examples of the ultraviolet absorber include 5-chloro-2-(3,5-di-sec-butyl-2-hydroxylphenyl)-2H-benzotriazole, (2-2H-benzotriazol-2-yl)-6-(straight chain and branched dodecyl)-4-methylphenol, 2-hydroxy-4-benzyloxybenzophenone, 2,4-benzyloxybenzophenone, and TINUVINs such as TINUVIN 109, TINUVIN 171, TINUVIN 234, TINUVIN 326, TINUVIN 327, TINUVIN 328, and TINUVIN 928 (manufactured by BASF Japan Ltd.).

The content of the ultraviolet absorber is preferably 0.5 to 10% by weight, and more preferably 0.6 to 4% by weight based on the optical film depending on the type of the ultraviolet absorber.

Antioxidant

Since film materials such as resin are melt-kneaded under high temperature in the step of producing a film according to a melt-extrusion method, the film materials such as resin are easily decomposed by heat and oxygen. The resin composition of the present invention preferably further contains an antioxidant as a stabilizing agent in order to reduce the decomposition of the film materials such as resin by heat and oxygen.

Examples of the antioxidant include a phenol-based compound, a hindered amine-based compound, a phosphorus-based compound, and a compound containing an unsaturated double bond. Examples of the phenol-based compound include a compound having a 2,6-dialkyl phenol structure (e.g., 2,6-di-t-butyl-p-cresol). Examples of the commercially available product of the phenol-based compound include Irganox1076 and Irganox1010 manufactured by BASF Japan Ltd., and ADK STAB AO-50 manufactured by ADEKA Corp.

Examples of the phosphorus-based compound include tris(2,4-di-t-butylphenyl)phosphite and bis(2,6-di-t-butyl-4-methylphenyl)pentaerythritol-diphosphite. Examples of the commercially available product of the phosphorus-based compound include SumilizerGP manufactured by Sumitomo Chemical Co., Ltd., ADK STAB PEP-24G, ADK STAB PEP-36, and ADK STAB 3010 manufactured by ADEKA Corp., IRGAFOS P-EPQ manufactured by BASF Japan Ltd., and GSY-P101 manufactured by Sakai Chemical Industry Co., Ltd.

Examples of the hindered amine-based compound include Tinuvin144 and Tinuvin770 manufactured by BASF Japan Ltd., and ADK STAB LA-52 manufactured by ADEKA Corp. These antioxidants may be used alone or as a mixture of two or more types.

Examples of the compound containing an unsaturated double bond include Sumilizer GM and Sumilizer GS manufactured by Sumitomo Chemical Co., Ltd.

The content of the antioxidant is preferably 1 ppm to 2.0% in a mass ratio, more preferably 10 ppm to 1.0%, and still more preferably 10 ppm to 0.1%, based on the resin component.

Fine Particles (Matting Agent)

The fine particles have a function of improving the slidability of the surface of the resultant optical film. The fine particles may be inorganic fine particles or organic fine particles. Examples of the inorganic fine particles include silicon dioxide and zirconium oxide. In order to lessen the increase in the haze of the film, silicon dioxide is particularly preferable.

Specific examples of silicon dioxide include Aerosil 200V, Aerosil R972V, Aerosils R972, R974, R812, 200, 300, 8202, OX50, TT600, and NAX50 (all manufactured by Nippon Aerosil Co., Ltd.), Seahostars KEP-10, KEP-30 and KEP-50 (all manufactured by Nippon Shokubai Co., Ltd.), Sylophobic 100 (manufactured by Fuji Silycia Chemical Ltd.), Nipsil E220A (manufactured by Nippon Silica Industries), and Admafine SO (manufactured by Admatechs).

The shape of the fine particles is irregular, needle, flat or spherical form. In order to secure the transparency of resultant the film, the spherical form is preferable.

The size of the primary particle or aggregate of the fine particles is preferably within a range of 80 to 180 nm in order to attain sufficient slidability. The size of the primary particle or aggregate of the fine particles can be obtained as the average value of the particle diameters of 100 particles by observing the particles at a magnification ratio of 500,000 to 2,000,000 with a transmission electron microscope.

The content of the fine particles is preferably 0.01 to 5.0% by weight, and more preferably 0.05 to 1.0% by weight, based on the above resin component. When the content of the fine particles is more than 5.0% by weight, aggregates cannot be reduced in number.

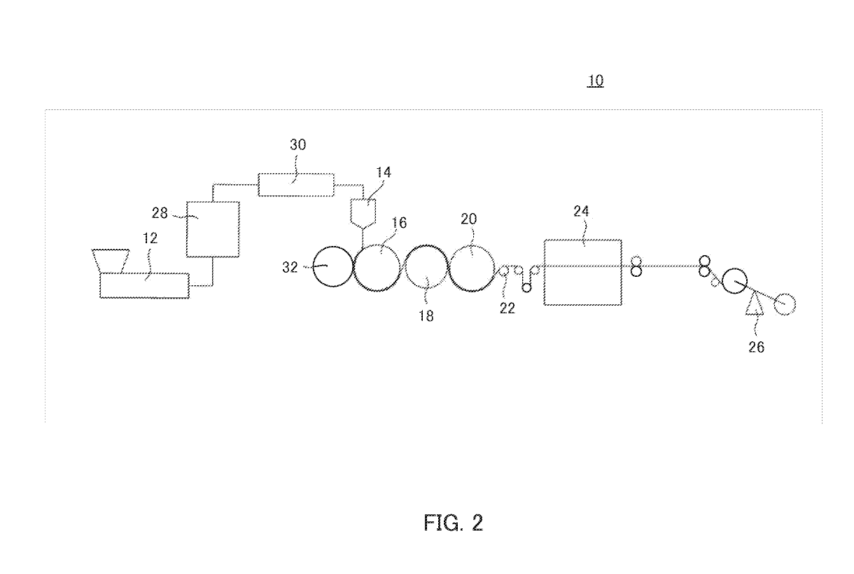

The above resin composition is melt-extruded to afford an optical film. First, a film forming apparatus to be used for the melt-extrusion method will be described. FIG. 2 schematically illustrates an example of the film forming apparatus. As shown in FIG. 2, film forming apparatus 10 has extruder 12 that melt-kneads a resin, die 14 that discharges the molten resin in film form, a plurality of cooling rolls 16, 18, and 20 that multistage-cool the high-temperature resin discharged from die 14, peeling roller 22 that peels the film obtained by cooling solidification, stretching apparatus 24 that stretches the film, and winding apparatus 26 that winds the stretched film.

Extruder 12 is a melt-kneading extruder, and has a cylinder and a screw rotatably provided in the cylinder. A hopper (not shown) that supplies film materials is provided in a supply port of the cylinder. The shape of the screw may be full flight, Maddock, and Dulmage or the like. The shape is selected according to the viscosity of the molten resin and a shearing force to be needed. Extruder 12 may be a single-screw extruder or a twin-screw extruder.

Filter 28 that filters the molten resin may be further provided between extruder 12 and die 14. Filter 28 may be a leaf disk type filter, for example. The filtering accuracy of the filter is preferably 3 to 15 μm. The material of the filter may be stainless steel, a sinter thereof or the like.

A mixer such as static mixer 30 for uniform resin mixing, a gear pump (not shown) for stabilizing the extrusion flow rate, or the like may be further provided between extruder 12 and die 14.

Die 14 may be a known die, and is a T die or the like. The material of die 14 may be hard chromium, chromium carbide, or the like. The lip clearance of die 14 is preferably 900 μm or more, and more preferably 1 mm to 2 mm.

When flaws or foreign substances such as concretions of the plasticizer adhere to the inner wall surface of die 14, streak-like defects (die lines) may be formed on the surface of the molten resin to be extruded. In order to decrease surface defects such as the die lines, it is preferable to make the inner wall surface between extruder 12 and the tip of die 14 to have a structure in which resin retaining portions hardly adhere; and for example, flaws are not formed on the inner wall surface between extruder 12 and the tip of die 14.

The inner wall surfaces of extruder 12 and die 14 or the like are preferably subjected to a surface treatment to decrease surface roughness or surface energy in order that the molten resin does not easily adhere to the inner wall surfaces. Examples of the surface treatment include a polishing treatment to have a surface roughness of 0.2 S or less after hard chromium plating and thermal ceramic spraying.

Cooling rolls 16, 18, and 20 are highly rigid metal rolls, and structured so that a temperature-controllable medium can be circulated in the interior thereof. The surface materials of cooling rolls 16, 18, and 20 may be stainless steel, aluminum, titanium or the like. The surfaces of cooling rolls 16, 18, and 20 may be subjected to surface treatments such as hard chromium plating in order to easily peel the resin. The surface roughness Ra of cooling rolls 16, 18, and 20 is preferably 0.1 μm or less, and more preferably 0.05 μm or less in order to maintain the haze of the resultant film.

Elastic touch roll 32 is disposed so as to be opposed to cooling roll 16. The molten resin extruded from die 14 is nipped by cooling roll 16 and elastic touch roll 32. A silicon rubber roll covered with a thin film metal sleeve, or the like is used as elastic touch roll 32. The silicon rubber roll is described in Japanese Patent Application Laid-Open Nos. 03-124425, 08-224772, and 07-100960.

Stretching apparatus 24 is not particularly limited. However, a roll stretching machine and a tenter stretching machine or the like are preferably used as stretching apparatus 24. The roll stretching machine and the tenter stretching machine may be combined. The tenter stretching machine preferably has a preheating zone, a stretching zone, a retaining zone, and a cooling zone. Preferably, the tenter stretching machine further has a neutral zone for heat insulation between the zones.

Next, a step of obtaining the optical film using film forming apparatus 10 will be described. For example, the optical film can be obtained by a step of preparing pellets of the above resin composition (pelletizing step); a step of melt-kneading a film material containing the pellets in extruder 12 and thereafter extruding the film material from die 14 (melt-extruding step); a step of cooling and solidifying the extruded molten resin to afford the film (cooling solidification step); and a step of stretching the film (stretching step).

Pelletizing Step

Preferably, the resin composition containing the above (meth)acrylic resin and cellulose ester resin is previously kneaded and pelletized. The pelletizing can be performed by known methods. For example, the above resin composition is melt-kneaded in the extruder, and then extruded in a strand form from the die. The molten resin extruded in a strand form is water-cooled or air cooled, and then cut, and thereby pellets can be obtained.

Raw materials for the pellets are preferably dried before being supplied to extruder 12 in order to prevent the decomposition. For example, the cellulose ester resin is preferably dried at 70 to 140° C. for 3 hours or more to set the moisture content to 200 ppm or less, and preferably 100 ppm or less because the cellulose ester resin tends to absorb moisture.

The antioxidant and the resin component may be solid-to-solid mixed; the resin component may be impregnated and mixed with the antioxidant dissolved in a solvent; or the antioxidant may be sprayed onto the resin component to mix the antioxidant and the resin component. Vacuum Nauta mixer or the like can simultaneously perform the drying and mixing of the raw materials, which is preferable. The atmospheres near the hopper of extruder 12 and near the outlet port of die 14 are preferably dehumidified air or N₂ gas or the like in order to prevent the deterioration of the raw materials for the pellets.

In extruder 12, the resin is preferably kneaded at a low shearing force or a low temperature in order to prevent the deterioration of the resin (the decrease in the molecular weight, and the coloring and the formation of gel-like matter, or the like). For example, when the resin is kneaded in the twin-screw extruder, the rotation directions of two screws are preferably set to the same direction by using a deep groove type screw. In order to uniformly knead the resin, two screw shapes preferably engage with each other.

The resin composition which is not melt-kneaded may be melt-knead as the raw material as it is in extruder 12 without pelletizing the resin composition, to produce the optical film.

Melt-Extruding Step

The obtained molten pellets and other additives if needed are supplied to the extruder from the hopper. The pellets are preferably supplied under a vacuum, a reduced pressure, or an inert gas atmosphere in order to prevent the oxidation decomposition of the pellets, or the like. The film material containing the molten pellets is melt-kneaded in extruder 12.

When the glass transition temperature of the film is defined as Tg° C., the melting temperature of the film material in extruder 12 is preferably within a range of Tg° C. to (Tg+100)° C., and more preferably within a range of (Tg+10)° C. to (Tg+90)° C., depending on the type of the film material. The retention time of the film material in extruder 12 is preferably 5 minutes or less. The retention time can be adjusted by the number of rotations of the screw, the depth of the groove, and L/D which is a ratio of a length (L) of the cylinder to an inner diameter (D) of the cylinder, or the like.

After the molten resin extruded from extruder 12 is filtered by filter 28 or the like, if needed, the molten resin is further mixed in static mixer 30 or the like, and extruded in a film form from die 14. The melting temperature Tm of the resin in the outlet port section of die 14 can be set to about 200 to 300° C.

Cooling Solidification Step

The resin extruded from the die is nipped by cooling roll 16 and elastic touch roll 32, to produce a film-like molten resin with a predetermined thickness. The film-like molten resin is then gradually cooled and solidified by a plurality of cooling rolls 18 and 20.

When the glass transition temperature of the resultant film is defined as Tg (° C.), surface temperature Tr1 of cooling roll 16 may be Tg (° C.) or less. Surface temperature Tr2 of second cooling roll 18 may be (Tg−50)° C.≦Tr2≦Tg° C. Surface temperature Tt of the film located on elastic touch roll 32 side may be (Tr1−50)° C.≦Tt≦(Tr1−5)° C.

The film-like molten resin solidified by cooling rolls 16, 18, and 20 is peeled by peeling roller 22 to afford a web. When the film-like molten resin is peeled, tension is preferably adjusted in order to prevent the deformation of the resultant web.

Stretching Step

The obtained web is stretched by stretching apparatus 24 to afford a film. The web may be stretched in at least one direction. The web is preferably stretched in both the transverse direction (TD direction) of the web and the machine direction (MD direction) of the web.

When the web is stretched in both the transverse direction (TD direction) of the web and the machine direction (MD direction) of the web, the web may be sequentially or simultaneously stretched in the transverse direction (TD direction) of the web and the machine direction (MD direction) of the web.

The stretching magnification ratio may be 1.01 to 3.0, and preferably 1.1 to 2.0, in each direction. When the web is stretched in both the transverse direction (TD direction) of the web and the machine direction (MD direction) of the web, the stretching magnification ratio is finally 1.01 to 3.0, and preferably 1.1 to 2.0, in each direction.

The stretching temperature is preferably Tg to (Tg+50)° C. The stretching temperature is preferably uniform in the transverse direction (TD direction) or machine direction (MD direction) of the web. The variation in the stretching temperature of the web in the transverse direction or the machine direction is preferably ±2° C. or less, more preferably ±1° C. or less, and still more preferably ±0.5° C. or less.

In order to adjust the retardation of the resultant film after stretching or to decrease a dimensional change, the resultant film after stretching may be contracted in the machine direction (MD direction) or the transverse direction (TD direction) if needed. In order to contract the resultant film after stretching in the machine direction (MD direction), for example, the film may be loosened in the machine direction by releasing clips gripping in the transverse direction; or the distance between clips adjacent to each other may be gradually narrowed in the machine direction to loosen the film in the machine direction.

The width of the resultant optical film is preferably 1.3 to 4 m, and more preferably 1.4 to 2.5 m.

The total content of the (meth)acrylic resin and cellulose ester resin in the resultant optical film is preferably 55% by weight or more, more preferably 60% by weight or more, and still more preferably 70% by weight or more, based on the optical film.

As described above, the (meth)acrylic resin obtained in the step (1) has a weight average molecular weight Mw of a specific value or less, and the contents of residual components of the unreacted monomer, the radical polymerization initiator, chain transfer agent and the like are adjusted to a specific value or less. Therefore, in the step (2), coloring of the resin and the formation of gel-like matter that occur when the (meth)acrylic resin and the cellulose ester resin are melt-kneaded can be limited. Therefore, coloring and formation of the gel-like matter in the resultant optical film can also be limited, and the haze can also be reduced.

### 2. Physical Properties of Optical Film

The thickness of the optical film is, but is not particularly limited to, preferably 20 to 200 μm, more preferably 25 to 100 μm, and still more preferably 30 to 80 μm. When the thickness of the film is too small, desired retardation cannot be easily obtained. On the other hand, when the thickness of the film is too large, the retardation tends to change under the influence of humidity or the like.

The number of defects existing in the surface of the optical film and having a diameter of 5 μm or more is preferably 1 defect/10 cm square or less, more preferably 0.5 defect/10 cm square or less, and still more preferably 0.1 defect/10 cm square or less. When the defect is a circle, the diameter of the defect refers to the diameter of the circle; and when the defect is not a circle, the range (area) of the defect is microscopically observed and determined according to the following procedure and the maximum diameter (circumscribed circle diameter) is defined as the diameter of the defect.

When the defect is a foreign substance or a bubble, the range of the defect is the size of the shadow when observing the defect by a differential interference microscope. When the defect involves a change in the surface shape such as transfer of a flaw on a roll or an abrasion the range of the defect is the size of a defect when the defect is observed by refection light of a differential interference microscope. When the size of a defect observed by refection light of a differential interference microscope is not clear, aluminum or platinum may be deposited on the surface to observe the surface.

In-plane retardation R₀ of the optical film measured at a wavelength of 590 nm under environments of 25° C. and 55% RH is preferably within a range of 0 nm to 100 nm, and more preferably within a range of 0 to 250 nm. Retardation Rt in the thickness direction is preferably within a range of −100 nm to 100 nm, and more preferably within a range of −50 nm to 50 nm. The retardation can be adjusted by the proportion of the (meth)acrylic resin and cellulose ester resin, a stretching condition or the like, for example.

The retardations R₀ and Rt are respectively represented by the following formulae.

Ro=(nx−ny)×d Formula (I)

Rt={(nx+ny)/2−nz}×d Formula (II)

(nx: an in-plane refractive index in the direction of the slow phase axis of the film, ny: an in-plane refractive index in the direction perpendicular to the slow phase axis, nz: a refractive index of the film in the direction of a thickness, and d: a thickness of the film (nm).)

The retardations R₀ and Rt can be obtained by, for example, the following method:

(1) The average refractive index of the film is measured by a refractometer;

(2) The in-plane retardation R₀ is measured by KOBRA-21ADH manufactured by Oji Scientific Instruments when allowing light having a wavelength of 590 nm to enter from the normal direction of a film;

(3) A retardation value R (θ) is measured by KOBRA-21ADH manufactured by Oji Scientific Instruments when allowing light having a wavelength of 590 nm to enter from an angle (incident angle (θ)) of θ to the normal direction of a film. θ is larger than 0 degree, and preferably 30 degrees to 50 degrees.

(4) From the measured R₀ and R (θ) and the above average refractive index and film thickness, nx, ny, and nz are calculated by KOBRA-21ADH manufactured by Oji Scientific Instruments, to calculate Rt. The retardation can be measured under conditions of 23° C. and 55% RH.

An angle θ1 (orientation angle) between the in-plane slow phase axis of the optical film and the transverse direction of the film is preferably −5 degrees or more and +5 degrees or less, and more preferably −1 degree or more and +1 degree or less. The orientation angle θ1 of the optical film can be measured by using an automatic double refractometer KOBRA-21ADH (Oji Scientific Instruments).

The haze of the optical film to be measured based on JIS K-7136 is preferably less than 1.0%, more preferably 0.2% or less, still more preferably 0.1% or less, and particularly preferably 0.05% or less. Among these, the haze of the optical film having a thickness of 40 μm is preferably within the above range. In order to decrease the haze of the optical film, as described above, for example, the amount of the residual components contained in the (meth)acrylic resin is preferably set to a specific value or less to limit coloring or the like.

The haze of the optical film can be measured by a method based on JIS K-7136; specifically, the following method:

(1) The obtained optical film is humidity-conditioned for 5 hours or more in environments of 23° C. and 55% RH. Then, dusts or the like adhering to the surface of the film are removed by a blower or the like.

(2) Then, the haze of the optical film is measured under conditions of 23° C. and 55% RH by a haze meter (turbidity meter) (model: NDH 2000 manufactured by Nippon Denshoku Industries Co., Ltd.). A halogen bulb of 5V and 9 W may be used as a light source of the haze meter, and a silicon photo cell (with a relative luminous efficiency filter) may be used as a light receiving section.

The visible light transmittance of the optical film is preferably 90% or more, and more preferably 93% or more.

The glass transition temperature of the optical film is preferably 110 to 200° C., and more preferably 120 to 190° C. The glass transition temperature of the optical film can be measured by a method based on JIS K7121 (1987). Specifically, the glass transition temperature can be measured as a midpoint glass transition temperature (Tmg) when the temperature of the optical film is increased at a temperature-increasing rate of 20° C./minute using a differential scanning calorimeter (DSC-7 model manufactured by PerkinElmer, Inc.).

The moisture permeability of the optical film at 40° C. and 90% RH to be measured based on JIS Z 0208 is preferably 200 to 1,500 (g/(m²·24 hr)), and more preferably 400 to 1,200 (g/(m²·24 hr)). In order to lower the moisture permeability of the optical film, for example, the content rate of a (meth)acrylic resin may be increased.

The fracture elongation of the optical film is preferably 10 to 80%, and more preferably 20 to 50%.

### 3. Polarizing Plate

A polarizing plate of the present invention includes a polarizer, and the above optical film disposed on at least one surface of the polarizer.

The polarizer is an element permitting only light of a polarized wave plane of a predetermined direction to pass. The typical example of the polarizer is a polyvinyl alcohol-based polarizing film. Examples of the polyvinyl alcohol-based polarizing film include those prepared by dyeing a polyvinyl alcohol-based film with iodine and those dyed with a dichroic dye.

The polarizer may be a film obtained by uniaxially stretching a polyvinyl alcohol-based film, and thereafter dyeing the stretched film with iodine or a dichroic dye, or a film obtained by dyeing a polyvinyl alcohol-based film with iodine or a dichroic dye, and thereafter uniaxially stretching the dyed film (preferably a film further subjected to a durability treatment using a boron compound). The thickness of the polarizer is preferably 5 to 30 μm, and more preferably 10 to 20 μm.

The polyvinyl alcohol-based film may be a film produced from a polyvinyl alcohol aqueous solution. As the polyvinyl alcohol-based film, an ethylene-modified polyvinyl alcohol film is preferable as it has excellent polarizing performance and durability performance, and minimal color spotting. Examples of the ethylene-modified polyvinyl alcohol film include films described in Japanese Patent Application Laid-Open Nos. 2003-248123 and 2003-342322. The ethylene-modified polyvinyl alcohol film has an ethylene unit content of 1 to 4 mol %, a polymerization degree of 2,000 to 4,000, and a saponification degree of 99.0 to 99.99 mol %.

Examples of the dichroic dye include an azo-based dye, a stilbene-based dye, a pyrazolone-based dye, a triphenylmethane-based dye, a quinoline-based dye, an oxazine-based dye, a thiazine-based dye, and an anthraquinone-based dye.

The above optical film may be directly disposed on at least one surface of the polarizer, or may be disposed with other film or layer interposed therebetween.

When the above optical film is disposed on one surface of the polarizer, a protective film (other protective film) other than the above optical film may be disposed on the other surface of the polarizer. The other protective film is not particularly limited, and may be a common cellulose ester film or the like. Preferable examples of the commercially available product of the cellulose ester film include commercially available cellulose ester films (e.g., Konica Minolta TAC KC8UX, KCSUX, KC8UCR3, KC8UCR4, KC8UCR5, KC8UY, KC6UY, KC4UY, KC4UE, KC8UE, KC8UY-HA, KC8UX-RHA, KC8UXW-RHA-C, KC8UXW-RHA-NC, and KC4UXW-RHA-NC, all manufactured by Konica Minolta Opto, Inc.).

The polarizing plate can be typically obtained by a step of laminating the polarizer and the above optical film. Preferable examples of an adhesive used for laminating include a completely saponified polyvinyl alcohol aqueous solution.

### 4. Liquid Crystal Display Device

A liquid crystal display device of the present invention has a liquid crystal cell, and a pair of polarizing plates between which the liquid crystal cell is sandwiched. At least one of the pair of polarizing plates has the above optical film. Preferably, both of the polarizing plates have the above optical film.

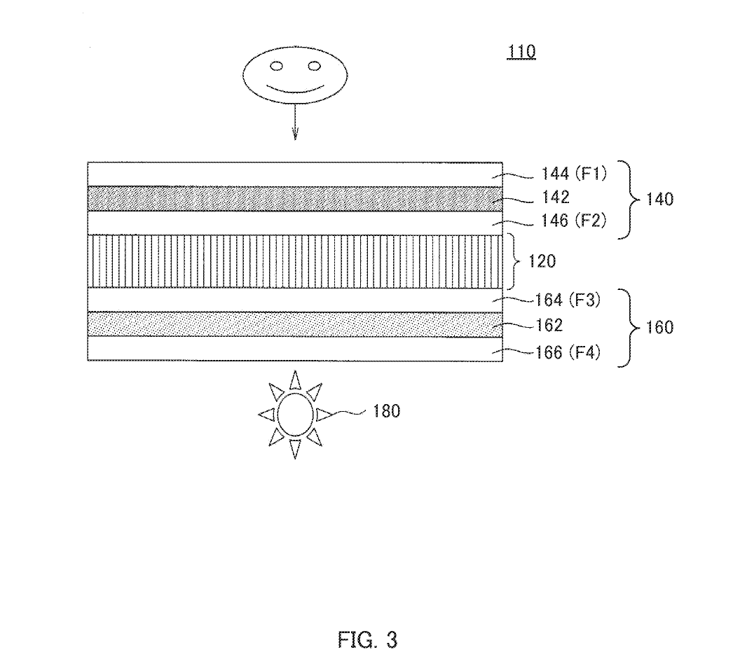

FIG. 3 schematically illustrates a basic constitution of an embodiment of a liquid crystal display device according to the present invention. As shown in FIG. 3, liquid crystal display device 110 has liquid crystal cell 120, first polarizing plate 140 and second polarizing plate 160 between which liquid crystal cell 120 is sandwiched, and backlight 180.

Examples of the display type of liquid crystal cell 120 include, but are not particularly limited to, TN (Twisted Nematic) type, STN (Super Twisted Nematic) type, IPS (In-Plane Switching) type, OCB (Optically Compensated Birefringence) type, VA (Vertical Alignment) type (also including MVA; Multi-domain Vertical Alignment and PVA; Patterned Vertical Alignment), and HAN (Hybrid Aligned Nematic) type. From the viewpoint of a comparatively large viewing angle or the like, the IPS type or the like is preferable. From the viewpoint of high contrast or the like, VA type is preferable, for example.

First polarizing plate 140 is disposed on the visual recognition side, and has first polarizer 142, protective film 144 (F1) to be disposed on the visual recognition side of first polarizer 142, and protective film 146 (F2) to be disposed on the liquid crystal cell side of first polarizer 142. Second polarizing plate 160 is disposed on a backlight 180 side, and has second polarizer 162, protective film 164 (F3) to be disposed on the liquid crystal cell side of second polarizer 162, and protective film 166 (F4) to be disposed on the backlight side of second polarizer 162. One of protective films 146 (F2) and 164 (F3) may not be provided if necessary.

Among protective films 144 (F1), 146 (F2), 164 (F3), and 166 (F4), at least one of protective films 146 (F2) and 164 (F3) to be disposed on the liquid crystal cell side is preferably the optical film of the present invention.

### EXAMPLES

Hereinafter, the present invention will be described in more detail with reference to Examples. The scope of the present invention should not be interpreted in a limited manner by these Examples.

1. Preparation of Optical Film Material

### (A) (Meth)Acrylic Resin

Monomers from which (meth)acrylic resin are produced are given below.

Methyl methacrylate (MMA): Asahi Kasei Chemicals Corporation

Acryloyl morpholine (ACMO): Kohjin Co., Ltd.

Methyl acrylate (MA): Toagosei Co., Ltd.

### Synthetic Example 1

A (meth)acrylic resin was synthesized according to a flow shown in FIG. 1 using the above monomer materials. That is, as shown in FIG. 1, 88.8% by weight of methyl methacrylate (MMA) and 11.2% by weight of acryloyl morpholine (ACMO) were charged into a 10 L catalyst dissolving tank (SUS304, with a paddle blade stirrer, with a jacket) (the charged molar ratio in total was MMA/ACMO=85/15); and 2,2′-azobis(2-methylpropionitrile) (AIBN) as a polymerization initiator was charged in an amount of 0.262% by weight based on the total amount of monomer components contained in a catalyst liquid and monomer mixed liquid to be described below. These components were stirred and mixed, to completely dissolve AIBN, thereby producing the catalyst liquid. A temperature inside the catalyst dissolving tank was adjusted to 5° C. by passing a refrigerant through the jacket. The obtained catalyst liquid was continuously sent to a 10 L polymerization reactor (SUS304, with a helical ribbon blade stirrer, with a jacket) at a flow rate of 1.47 kg/Hr by a pump.

On the other hand, 88.8% by weight of methyl methacrylate (MMA) and 11.2% by weight of acryloyl morpholine (ACMO) were charged into a 20 L monomer blending tank (SUS304, with a paddle blade stirrer, with a jacket); and n-octyl mercaptan as a chain transfer agent was further charged in an amount of 0.137% by weight based on the total amount of the monomer components contained in the above catalyst liquid and monomer mixed liquid, and these components were stirred and mixed. A temperature inside the monomer blending tank was adjusted to 5° C. by passing a refrigerant through the jacket. The obtained monomer mixed liquid was sent to the above polymerization reactor at a flow rate of 13.279 kg/Hr by a pump.

The above catalyst liquid and monomer mixed liquid were charged from the lower section of the polymerization reactor. These were subjected to a polymerization reaction until an average polymerization rate increased to 56% by weight at a temperature of 175° C.±2° C. for an average retention time of 26 minutes to afford a liquid polymer composition. Then, the obtained liquid polymer composition was taken out from the upper section of the polymerization reactor, and sent to a heater (inner diameter: 16.7 mm×length: 3 m, with a jacket).

While the liquid polymer composition was heated to 20 kg/cm² G and 200° C. in the heater, the obtained polymer composition was sent to a devolatilization extruder. A twin-screw extruder (TEX-30) manufactured by Japan Steel Works, Ltd. was used as the devolatilization extruder. The twin-screw extruder had a system rotating in different directions, and had a screw diameter of 30 mm, and a cylinder length of 1,200 mm. The twin-screw extruder included a rear vent, and three fore vents. The liquid polymer composition was devolatilized in a state where the pressure of each vent of the devolatilization extruder was reduced and a cylinder temperature was set to about 250° C., to take out a volatile matter composed mainly of an unreacted monomer from the vent. The taken-out unreacted monomer was recovered to a monomer recovery tower (inner diameter: 100 mm, length: 3 m, SUS304, packed column equipped with ⅜ inch SUS Raschig ring, length of concentration section: 0.7 m, and length of recovery section: 0.3 m).

The obtained molten polymer was extruded in a strand form, water-cooled, and then cut to afford pellets. Thus, (meth)acrylic resin A1-1 was obtained at an average rate of 13.5 kg/hr.

The contents of the monomer, polymerization initiator, and chain transfer agent remaining in obtained (meth)acrylic resin A1-1 were measured by the following method. That is, 0.1 g of the (meth)acrylic resin was dissolved in 2 mL of acetone, and subjected to an ultrasonic treatment for 30 minutes. 50 ppm of ethylene glycol monomethyl ether as an internal standard component was added to the solution, and the solution was then made up to 10 mL with hexane to prepare a sample solution. The amounts of the monomer, polymerization initiator, and chain transfer agent which were contained in the sample solution were each measured by GC/MS. A measuring instrument and measurement conditions for GC/MS are as follows.

Instrument: HP 6890GC/HP5973MSD (manufactured by Hewlett-Packard Co.)
Column: DB-624 (0.25 mmi.d.×30 ML.) manufactured by J&W
Oven Program: 40° C. (3 min)-20° C./min-230° C. (8 min)

### Inj: 160° C.

### AUX: 250° C.

### Synthetic Examples 2 to 5

(Meth)acrylic resins A1-2 to A1-5 were obtained in the same manner as in Synthetic Example 1 except that an amount of a volatile component (containing a monomer) discharged from a vent of a devolatilization extruder, and a polymerization temperature or a polymerization time in a polymerization reactor were changed so that the contents of residual monomers were within ranges shown in Table 1. For example, when the amount of the volatile component discharged is increased to decrease the amount of the residual monomer, the molecular weight of the resultant resin may be slightly decreased. In this case, the molecular weight of the resultant resin was adjusted by adjusting the polymerization temperature and the polymerization time or the like.

### Synthetic Examples 6 to 9

(Meth)acrylic resins A1-6 to A1-9 were obtained in the same manner as in Synthetic Example 1 except that a charging amount of a polymerization initiator to a catalyst blending tank, and a polymerization temperature or a polymerization time in a polymerization reactor were changed so that the contents of residual polymerization initiators were within ranges shown in Table 1. For example, when the charging amount of the polymerization initiator is decreased to decrease the amount of the residual polymerization initiator, the molecular weight of the resultant resin may be increased. In this case, the molecular weight of the resultant resin was adjusted by adjusting the polymerization temperature, polymerization time, and the like.

### Synthetic Examples 10 to 13

(Meth)acrylic resins A1-10 to A1-13 were obtained in the same manner as in Synthetic Example 1 except that a charging amount of a chain transfer agent to a monomer blending tank, and a polymerization temperature or a polymerization time in a polymerization reactor were changed so that the contents of residual chain transfer agents were within ranges shown in Table 1. For example, when the charging amount of the chain transfer agent is decreased to decrease the amount of the residual chain transfer agent, the molecular weight of the resultant resin may be increased. In this case, the molecular weight of the resultant resin was adjusted by adjusting the polymerization temperature and the polymerization time or the like.

### Synthetic Examples 14 and 15

(Meth)acrylic resins A1-14 and A1-15 were obtained in the same manner as in Synthetic Example 1 except that monomer compositions of (meth)acrylic resins were changed as shown in Table 1.

### Synthetic Example 16

(Meth)acrylic resin A1-16 was obtained in the same manner as in Synthetic Example 1 except that methyl acrylate (MA) as a raw material monomer was charged into a catalyst blending tank and a monomer blending tank so that a charged molar ratio was set to MMA/ACMO/MA=75/15/10.

### Synthetic Examples 17 to 22

(Meth)acrylic resins A1-17 to A1-22 were obtained in the same manner as in Synthetic Example 1 except that a charging amount of a radical polymerization initiator and a polymerization time in a polymerization reactor were changed so that weight average molecular weights Mw of the resultant (meth)acrylic resins were within ranges shown in Table 1.

The compositions and physical properties of the obtained (meth)acrylic resins were summarized in Table 1.

TABLE 1

| | Monomer composition | | | | | | | Remaining component | | |
|---|---|---|---|---|---|---|---|---|---|---|
| | | Composition | Copoly- | Composition | Copoly- | Composition | Molecular | Monomer | Polymerization | Chain transfer |
| | Monomer | ratio | merizable | ratio | merizable | ratio | weight | content | initiator content | agent content |
| No. | unit | (molar ratio) | monomer 1 | (molar ratio) | monomer 2 | (molar ratio) | Mw | (% by weight) | (% by weight) | (% by weight) |
| A1-1 | MMA | 85 | ACMO | 15 | — | — | 100000 | 0.5 | 0.1 | 0.1 |
| A1-2 | | | | | | | 100000 | 0.02 | 0.1 | 0.1 |
| A1-3 | | | | | | | 100000 | 0.05 | 0.1 | 0.1 |
| A1-4 | | | | | | | 100000 | 1 | 0.1 | 0.1 |
| A1-5 | | | | | | | 100000 | 1.5 | 0.1 | 0.1 |
| A1-6 | MMA | 85 | ACMO | 15 | — | — | 100000 | 0.5 | 0.005 | 0.1 |
| A1-7 | | | | | | | 100000 | 0.5 | 0.01 | 0.1 |
| A1-8 | | | | | | | 100000 | 0.5 | 0.5 | 0.1 |
| A1-9 | | | | | | | 100000 | 0.5 | 1 | 0.1 |
| A1-10 | MMA | 85 | ACMO | 15 | — | — | 100000 | 0.5 | 0.1 | 0.005 |
| A1-11 | | | | | | | 100000 | 0.5 | 0.1 | 0.01 |
| A1-12 | | | | | | | 100000 | 0.5 | 0.1 | 0.5 |
| A1-13 | | | | | | | 100000 | 0.5 | 0.1 | 1 |
| A1-14 | MMA | 70 | ACMO | 30 | — | — | 100000 | 0.5 | 0.1 | 0.1 |
| A1-15 | | 30 | | 70 | | | 100000 | 0.5 | 0.1 | 0.1 |
| A1-16 | MMA | 75 | ACMO | 15 | MA | 10 | 10000 | 0.5 | 0.1 | 0.1 |
| A1-17 | MMA | 85 | ACMO | 15 | — | — | 10000 | 1.5 | 1 | 1 |
| A1-18 | | | | | | | 20000 | 1 | 0.5 | 0.5 |
| A1-19 | | | | | | | 50000 | 0.5 | 0.5 | 0.5 |
| A1-20 | | | | | | | 200000 | 0.05 | 0.1 | 0.1 |
| A1-21 | | | | | | | 500000 | 0.05 | 0.01 | 0.01 |
| A1-22 | | | | | | | 800000 | 0.02 | 0.005 | 0.005 |

### (B) Preparation of Cellulose Ester Resins

Cellulose ester resins listed in the following Table were prepared. In the Table, Dac represents a degree of acetyl substitution; Dpr represents a degree of propionyl substitution; and Dall represents a total degree of acyl substitution.

TABLE 2

| | | | | Weight average |
|---|---|---|---|---|
| No. | Dac | Dpr | Dall | molecular weight Mw |
| C-1 | 2.9 | — | 2.9 | 200000 |
| C-2 | — | 1.9 | 1.9 | 200000 |
| C-3 | — | 2.1 | 2.1 | 200000 |
| C-4 | — | 2.89 | 2.89 | 200000 |
| C-5 | 0.5 | 1.7 | 2.2 | 200000 |
| C-6 | 0.5 | 2.3 | 2.8 | 200000 |
| C-7 | 0.8 | 1.3 | 2.1 | 200000 |
| C-8 | 0.8 | 2 | 2.8 | 200000 |
| C-9 | 1.05 | 1.1 | 2.15 | 200000 |
| C-10 | 1.05 | 1.3 | 2.35 | 200000 |
| C-11 | 1.04 | 1.5 | 2.9 | 200000 |
| C-12 | 0.19 | 2.56 | 2.75 | 70000 |
| C-13 | 0.19 | 2.56 | 2.75 | 80000 |
| C-14 | 0.19 | 2.56 | 2.75 | 200000 |
| C-15 | 0.19 | 2.56 | 2.75 | 250000 |
| C-16 | 0.19 | 2.56 | 2.75 | 320000 |

2. Preparation of Optical Film

### Example 1

The following components were dried while the components were mixed for 3 hours under conditions of 80° C. and 1 Torr in a vacuum Nauta mixer to afford a mixture.

### <Composition of Mixture>

(Meth)acrylic resin A1-1 (dried at 90° C. for 3 hours to set a moisture content to 1,000 ppm) obtained in Synthetic Example 1: 65 parts by weight

Cellulose ester resin C-14 (cellulose acetate propionate having a degree of acyl substitution: 2.75, a degree of acetyl substitution: 0.19, a degree of propionyl substitution: 2.56, Mw: 200,000, dried at 100° C. for 3 hours to set a moisture content to 500 ppm): 35 parts by weight

Tinuvin 928 (manufactured by BASF Japan Ltd.): 1.1 parts by weight
GSY-P101 (manufactured by Sakai Chemical Industry Co., Ltd.): 0.25 part by weight
Irganox1010 (manufactured by BASF Japan Ltd.): 0.5 part by weight
SumilizerGS (manufactured by Sumitomo Chemical Co., Ltd.): 0.24 part by weight
Aerosil NAX50 (manufactured by Nippon Aerosil Co., Ltd.): 0.2 part by weight
Seahostar KEP-30 (manufactured by Nippon Shokubai Co., Ltd.): 0.02 part by weight

The obtained mixture was melt-kneaded at 235° C. in a twin-screw type extruder, and extruded in a strand form. The resin composition extruded in a strand form was water-cooled, and cut to afford pellets.

The obtained pellets were dried by circulating dehumidified air of 70° C. for 5 hours or more, and then charged into a single-screw extruder while a temperature of 100° C. was maintained. The moisture content of the pellets to be charged into the single-screw extruder was 120 ppm.

A film was produced by a film forming apparatus shown in FIG. 2 using the obtained pellets. That is, the obtained pellets were melt-kneaded at 235° C. in the single-screw extruder (extruder 12), and then extruded onto cooling roll 16 having a surface temperature of 90° C. from a T die (die 14). The resin extruded onto cooling roll 16 was pressed by elastic touch roll 32 having a surface on which a metal layer having a thickness of 2 mm was formed, and then further cooled by cooling roll 18 and cooling roll 20 to afford a web having a thickness of 120 μm.

The cooled and solidified web was peeled by peeling roll 22, and then stretched at a stretching magnification ratio of 1.6 (60%) at 175° C. in the machine direction (MD direction) of the web by roll stretching machine (stretching apparatus 24). The obtained film was introduced into a tenter stretching machine having a preheating zone, a stretching zone, a retaining zone, and a cooling zone and further having a neutral zone between the zones. The film was stretched at stretching magnification ratio of 1.7 (70%) at 175° C. in the transverse direction (TD direction) of the film by the tenter stretching machine (stretching apparatus 24). Then, the film was cooled until the film temperature was decreased to 30° C., and the clips of the tenter stretching machine were removed. The both ends of the film in the transverse direction were cut off to afford an optical film having a film thickness of 40 μm and a film width of 2,500 mm.

### Examples 2 to 7

Optical films were obtained in the same manner as in Example 1 except that the contents of residual components of (meth)acrylic resin A1 were changed as shown in Table 3.

### Examples 8 to 10

Optical films were obtained in the same manner as in Example 1 except that the composition of (meth)acrylic resin A1 was changed as shown in Table 4.

### Examples 11 to 14

Optical films were obtained in the same manner as in Example 1 except that the molecular weight and contents of residual components of (meth)acrylic resin A1 were changed as shown in Table 4.

### Example 15

An optical film was obtained in the same manner as in Example 1 except that PMMA (molecular weight Mw=100,000) as a (meth)acrylic resin A2 was further mixed, to change the composition of a resin composition.

### Examples 16 to 30

Optical films were obtained in the same manner as in Example 1 except that the type of a cellulose ester resin was changed as shown in Table 5.

### Examples 31 and 32

Optical films were obtained in the same manner as in Example 1 except that the proportion of a (meth)acrylic resin and cellulose ester resin was changed as shown in Table 5.

### Comparative Examples 1 to 6

Optical films were obtained in the same manner as in Example 1 except that the contents of the residual components of (meth)acrylic resin A1 were changed as shown in Table 3.

### Comparative Examples 7 to 19

Optical films were obtained in the same manner as in Examples 1 to 7 or Comparative Examples 1 to 6 respectively except that a cellulose ester resin was not contained as shown in Table 3.

### Comparative Examples 20 and 21

Optical films were obtained in the same manner as in Example 1 except that the molecular weight and contents of residual components of (meth)acrylic resin A1 were changed as shown in Table 4.

### Comparative Example 22

An optical film was obtained in the same manner as in Example 1 except that the proportion of a (meth)acrylic resin and cellulose ester resin was changed as shown in Table 5.

(1) The coloring, (2) gel-like matter, (3) brittleness, (4) adhesiveness with the polarizer, and (5) haze, of the obtained optical films were measured by the following method. Any measurement was performed in the 23° C. and 55% RH atmosphere. The optical films were used, which were previously stored for 24 hours in the 23° C. and 55% RH atmosphere.

(1) Coloring

10 mg of a finely pulverized optical film was put into an aluminum pan, and heated at 250° C. for 60 minutes under an N₂ flow using TG/DTA6200 (manufactured by SII Nano Technology Inc.). The colored state of the optical film in the heated aluminum pan was visually observed. The coloring was evaluated under the following criteria.

A: Scarcely colored
B: Faintly colored

C: Colored in brown

(2) Gel-Like Matter

10 mg of a finely pulverized optical film was put into an aluminum pan, and heated at 260° C. for 60 minutes under an N₂ flow using TG/DTA6200 (manufactured by SII Nano Technology Inc.). The heated aluminum pan including the optical film was put into a 10 mL measuring flask, and this was made up to 10 mL with THF (tetrahydrofuran). The molten state of the optical film in the aluminum pan after storing at 23° C. for 24 hours was visually observed. The presence or absence of the gel-like matter was observed under the following criteria.

A: No non-molten residue (gel).
B: Although most part of the optical film is molten, a slight amount of non-molten residue (gel) remains.
C: Most part of the optical film is a non-molten residue (gel).

(3) Brittleness

A circle hole was formed in the obtained optical film by a punch, and the shape of the cut edge was visually observed. The brittleness of the film was evaluated under the following criteria.

A: No cracks in the cut edge, and a smooth circular hole is opened.
B: Although there are slight cracks in the cut edge, there is no crack having a length equal to or greater than half of the diameter of the hole.
C: There are cracks having a length equal to or greater than half of the diameter of the hole.

(4) Adhesiveness with Polarizer

### (Preparation of Polarizer)

A long roll polyvinyl alcohol film having a thickness of 120 μm was immersed in 100 parts by weight of an aqueous solution containing 1 part by weight of iodine and 4 parts by weight of boric acid, and stretched at 50° C. in the machine direction by a stretching magnification ratio of 6 to afford a polarizer having a thickness of 20 μm.

Preparation of Polarizing Plate

As described below, the obtained optical films were subjected to alkaline saponification, and then subjected to water washing, neutralization, water washing in the following order. Then, the obtained optical films were dried at 80° C.

Saponification process: 2M-NaOH, 50° C., 90 seconds
Water washing process: water, 30° C., 45 seconds
Neutralization process: 10% by weight HCl, 30° C., 45 seconds
Water washing process: water, 30° C., 45 seconds

Similarly, KC4UY manufactured by Konica Minolta Opto, Inc. was also subjected to alkaline saponification. The KC4UY subjected to alkaline saponification was laminated on one surface of the above polarizer by using a 5% aqueous solution of a completely saponified polyvinyl alcohol as an adhesive. Similarly, the optical film subjected to alkaline saponification was laminated on the other surface of the polarizer by using a 5% aqueous solution of a completely saponified polyvinyl alcohol as an adhesive. The lamination was performed so that the transmission axis of a polarizer and the in-plane slow phase axis of an optical film were parallel. The laminated product was dried to afford a polarizing plate.

After the obtained polarizing plate was cut out into a rectangle, the optical film was peeled from the polarizer while the four corner sections were stroked by hand. The peeled conditions in the corner sections of the polarizing plate were visually observed.

The adhesiveness with the polarizer was evaluated under the following criteria.

A: At least one corner of the four corners of the optical film is immediately torn, and cannot be peeled. The remaining corners can be peeled into small pieces.
B: All the four corners of the optical film can be peeled into small pieces.
C: All the four corners of the optical film can be easily peeled.

(5) Haze

The haze of the obtained optical film was measured by a method based on JIS K-7136; specifically, the following method.

(1) The obtained optical film was humidity-conditioned for 5 hours or more in environments of 23° C. and 55% RH. Then, dusts or the like adhering to the surface of the film were removed by a blower or the like.

(2) Then, the haze of the optical film was measured under conditions of 23° C. and 55% RH by a haze meter (turbidity meter) (model: NDH 2000 manufactured by Nippon Denshoku Industries Co., Ltd.). A halogen bulb of 5V and 9 W was used as a light source of the haze meter, and a silicon photo cell (with a relative luminous efficiency filter) was used as a light receiving section. The obtained haze was evaluated under the following criteria.

A: Haze of less than 0.2%
B: Haze of 0.2% or more and less than 1.0%
C: Haze of 1.0% or more

The evaluation results of the optical films of Examples 1 to 7 and Comparative Examples 1 to 19 are shown in Table 3; the evaluation results of the optical films of Examples 8 to 15 and Comparative Examples 20 and 21 in Table 4; and the evaluation results of Examples 16 to 32 and Comparative Example 22 in Table 5.

TABLE 3

| | (Meth)acrylic resin A | | | | | | | | | | | | | |
|---|---|---|---|---|---|---|---|---|---|---|---|---|---|---|
| | A1 | | | | | | | | | | | | | |
| | | | | | Residual | Residual | | | | | | | | |
| | | | | Residual | polymer- | chain | | | | | | | | |
| | | | | monomer | ization | transfer | | Cellulose | A1/ | | | | | |
| | | | | content | initiator | agent | | ester | A2/B | Evaluation | | | | |
| | | Compo- | | (% by | content (% | content (% | | resin | (weight | | | Brittle- | Polarizer | |
| | No. | sition | Mw | weight) | by weight) | by weight) | A2 | B No. | ratio) | Coloring | Gel | ness | adhesiveness | Haze |
| Example 1 | A1-1 | MMA/ | 100000 | 0.5 | 0.1 | 0.1 | — | C-14 | 65/0/35 | A | A | A | A | A |
| Example 2 | A1-3 | ACMO = | | 0.05 | 0.1 | 0.1 | | | | A | A | B | A | A |
| Example 3 | A1-4 | 85/15 | | 1 | 0.1 | 0.1 | | | | B | B | A | A | A |
| Example 4 | A1-7 | | | 0.5 | 0.01 | 0.1 | | | | A | A | A | B | A |
| Example 5 | A1-8 | | | 0.5 | 0.5 | 0.1 | | | | B | B | A | A | A |
| Example 6 | A1-11 | | | 0.5 | 0.1 | 0.01 | | | | A | A | B | A | A |
| Example 7 | A1-12 | | | 0.5 | 0.1 | 0.5 | | | | B | B | A | A | A |
| Comparative | A1-13 | MMA/ | 100000 | 0.5 | 0.1 | 1 | — | C-14 | 65/0/35 | C | B | A | A | A |
| Example 1 | | ACMO = | | | | | | | | | | | | |
| Comparative | A1-2 | 85/15 | | 0.02 | 0.1 | 0.1 | | | | A | A | C | A | A |
| Example 2 | | | | | | | | | | | | | | |
| Comparative | A1-5 | | | 1.5 | 0.1 | 0.1 | | | | B | C | A | A | A |
| Example 3 | | | | | | | | | | | | | | |
| Comparative | A1-6 | | | 0.5 | 0.005 | 0.1 | | | | A | A | A | C | A |
| Example 4 | | | | | | | | | | | | | | |
| Comparative | A1-9 | | | 0.5 | 1 | 0.1 | | | | C | B | A | A | A |
| Example 5 | | | | | | | | | | | | | | |
| Comparative | A1-10 | | | 0.5 | 0.1 | 0.005 | | | | A | A | C | A | A |
| Example 6 | | | | | | | | | | | | | | |
| Comparative | A1-1 | MMA/ | 100000 | 0.5 | 0.1 | 0.1 | — | — | 100 | A | A | A | C | A |
| Example 7 | | ACMO = | | | | | | | | | | | | |
| Comparative | A1-3 | 85/15 | | 0.05 | 0.1 | 0.1 | | | | A | A | B | C | A |
| Example 8 | | | | | | | | | | | | | | |
| Comparative | A1-4 | | | 1 | 0.1 | 0.1 | | | | A | A | A | C | A |
| Example 9 | | | | | | | | | | | | | | |
| Comparative | A1-7 | | | 0.5 | 0.01 | 0.1 | | | | A | A | A | C | A |
| Example 10 | | | | | | | | | | | | | | |
| Comparative | A1-8 | | | 0.5 | 0.5 | 0.1 | | | | A | A | A | C | A |
| Example 11 | | | | | | | | | | | | | | |
| Comparative | A1-11 | | | 0.5 | 0.1 | 0.01 | | | | A | A | B | C | A |
| Example 12 | | | | | | | | | | | | | | |
| Comparative | A1-12 | | | 0.5 | 0.1 | 0.5 | | | | A | A | A | C | A |
| Example 13 | | | | | | | | | | | | | | |
| Comparative | A1-10 | MMA/ | 100000 | 0.5 | 0.1 | 0.005 | — | — | 100 | A | A | C | C | A |
| Example 14 | | ACMO = | | | | | | | | | | | | |
| Comparative | A1-13 | 85/15 | | 0.5 | 0.1 | 1 | | | | B | A | A | C | A |
| Example 15 | | | | | | | | | | | | | | |
| Comparative | A1-2 | | | 0.02 | 0.1 | 0.1 | | | | A | A | C | C | A |
| Example 16 | | | | | | | | | | | | | | |
| Comparative | A1-5 | | | 1.5 | 0.1 | 0.1 | | | | A | B | A | C | A |
| Example 17 | | | | | | | | | | | | | | |
| Comparative | A1-6 | | | 0.5 | 0.005 | 0.1 | | | | A | A | A | C | A |
| Example 18 | | | | | | | | | | | | | | |
| Comparative | A1-9 | | | 0.5 | 1 | 0.1 | | | | B | A | A | C | A |
| Example 19 | | | | | | | | | | | | | | |

TABLE 4

| | (Meth)acrylic resin A | | | | | | | | | | | | | |
|---|---|---|---|---|---|---|---|---|---|---|---|---|---|---|
| | A1 | | | | | | | | | | | | | |
| | | | | | Residual | Residual | | | | | | | | |
| | | | | | polymer- | chain | | | | | | | | |
| | | | | Residual | ization | transfer | | | | | | | | |
| | | | | monomer | initiator | agent | | Cellulose | A1/ | Evaluation | | | | |
| | | | | content | content | content | | ester | A2/B | | | | Polarizer | |
| | | Compo- | | (% by | (% by | (% by | | resin | (weight | Color- | | Brittle- | adhe- | |
| | No. | sition | Mw | weight) | weight) | weight) | A2 | B No. | ratio) | ing | Gel | ness | siveness | Haze |
| Example 8 | A1-14 | MMA/ | 100000 | 0.5 | 0.1 | 0.1 | — | C-14 | 65/0/35 | A | A | A | A | A |
| | | ACMO = | | | | | | | | | | | | |
| | | 70/30 | | | | | | | | | | | | |
| Example 9 | A1-15 | MMA/ | 100000 | 0.5 | 0.1 | 0.1 | | | | A | A | B | A | A |
| | | ACMO = | | | | | | | | | | | | |
| | | 30/70 | | | | | | | | | | | | |
| Example 10 | A1-16 | MMA/ | 10000 | 0.5 | 0.1 | 0.1 | | | | A | A | A | A | A |
| | | ACMO/ | | | | | | | | | | | | |
| | | MA = | | | | | | | | | | | | |
| | | 75/15/10 | | | | | | | | | | | | |
| Example 11 | A1-18 | MMA/ | 20000 | 1 | 0.5 | 0.5 | — | C-14 | 65/0/35 | B | A | B | A | A |
| Example 12 | A1-19 | ACMO = | 50000 | 0.5 | 0.5 | 0.5 | | | | A | A | A | A | A |
| Example 13 | A1-20 | 85/15 | 200000 | 0.05 | 0.1 | 0.1 | | | | A | A | A | A | A |
| Example 14 | A1-21 | | 500000 | 0.05 | 0.01 | 0.01 | | | | A | B | A | B | A |
| Example 15 | A1-1 | MMA/ | 100000 | 0.5 | 0.1 | 0.1 | *PMMA | C-14 | 55/10/35 | A | A | A | A | B |
| | | ACMO = | | | | | | | | | | | | |
| | | 85/15 | | | | | | | | | | | | |
| Comparative | A1-17 | MMA/ | 10000 | 1.5 | 1 | 1 | — | C-14 | 65/0/35 | C | C | C | A | A |
| Example 20 | | ACMO = | | | | | | | | | | | | |
| Comparative | A1-22 | 85/15 | 800000 | 0.02 | 0.005 | 0.005 | | | | Extrusion was not possible | | | | |
| Example 21 | | | | | | | | | | | | | | |

*PMMA: Molecular weight: 100,000

TABLE 5

| | (Meth)acrylic resin A | | | | | | | | | | | | | |
|---|---|---|---|---|---|---|---|---|---|---|---|---|---|---|
| | A1 | | | | | | | | | | | | | |
| | | | | | Residual | Residual | | | | | | | | |
| | | | | Residual | polymer- | chain | | | | | | | | |
| | | | | monomer | ization | transfer | | Cellulose | A1/ | | | | | |
| | | | | content | initiator | agent | | ester | A2/B | Evaluation | | | | |
| | | Compo- | | (% by | content (% | content (% | | resin B | (weight | Color- | | Brittle- | Polarizer | |
| | No. | sition | Mw | weight) | by weight) | by weight) | A2 | No. | ratio) | ing | Gel | ness | adhesiveness | Haze |
| Example 16 | A1-1 | MMA/ | 100000 | 0.5 | 0.1 | 0.1 | — | C-7 | 65/0/35 | A | A | A | A | A |
| Example 17 | | ACMO = | | | | | | C-8 | | A | A | A | A | A |
| Example 18 | | 85/15 | | | | | | C-3 | | A | A | A | A | A |
| Example 19 | | | | | | | | C-2 | | A | A | A | A | B |
| Example 20 | | | | | | | | C-4 | | A | A | A | A | A |
| Example 21 | | | | | | | | C-10 | | A | A | A | A | A |
| Example 22 | | | | | | | | C-9 | | A | A | A | A | B |
| Example 23 | | | | | | | | C-11 | | A | A | A | A | A |
| Example 24 | | | | | | | | C-1 | | A | A | A | A | B |
| Example 25 | | | | | | | | C-5 | | A | A | A | A | A |
| Example 26 | | | | | | | | C-6 | | A | A | A | A | A |
| Example 27 | | | | | | | | C-12 | | A | A | B | A | A |
| Example 28 | | | | | | | | C-13 | | A | A | A | A | A |
| Example 29 | | | | | | | | C-15 | | A | A | A | A | A |
| Example 30 | | | | | | | | C-16 | | A | A | A | A | B |
| Example 31 | A1-1 | MMA/ | 100000 | 0.5 | 0.1 | 0.1 | — | C-14 | 95/0/5 | A | A | A | B | A |
| Example 32 | | ACMO = | | | | | | | 30/0/70 | A | A | A | A | A |
| | | 85/15 | | | | | | | | | | | | |
| Comparative | A1-1 | MMA/ | 100000 | 0.5 | 0.1 | 0.1 | — | C-14 | 20/0/80 | A | A | C | A | A |
| Example 22 | | ACMO = | | | | | | | | | | | | |
| | | 85/15 | | | | | | | | | | | | |

The optical films of Examples 1 to 32 in which the amount of the residual components contained in (meth)acrylic resin A1 was a specific value or less and the molecular weight Mw was a specific value or less were found to have less coloring and gel-like matter, and a low haze. On the other hand, the optical films of Comparative Examples 1, 3, and 5 in which the amount of the residual components contained in (meth)acrylic resin A1 was large or the optical film of Comparative Example 20 in which the molecular weight Mw of (meth)acrylic resin A1 was too small were found to have more coloring and gel-like matter. The resin composition containing (meth)acrylic resin A1-22 in which the molecular weight Mw was too large provided a too high viscosity of the melt, and could not be melt-extruded, which could not be produced as the film.

On the other hand, according to comparison between Comparative Examples 1 to 6 and Comparative Examples 14 to 19, it is shown that even when the conventional single (meth)acrylic resin is molten, coloring does not occur and gel-like matter is not formed and that when the mixture of the conventional (meth)acrylic resin and cellulose ester resin is molten, coloring does not occur and gel-like matter is not formed. Consequently, one of the causes of coloring and gel-like matter is demonstrated to be the action of the residual components contained in the (meth)acrylic resin on the cellulose ester resin.

The optical film of Example 8 having a high proportion of a constitutional unit derived from methyl methacrylate in (meth)acrylic resin A1 is found to have higher flexibility (lower brittleness) than the optical film of Example 9 having a low proportion of a constitutional unit derived from methyl methacrylate.

The optical film of Example 19 in which the degree of acyl substitution of the cellulose ester resin is too low, the optical film of Example 22 containing cellulose acetate propionate in which the degree of acyl substitution having carbon atoms of 3 or more is too low, and the optical film of Example 24 containing cellulose acetate are found to have slightly low compatibility with (meth)acrylic resin A1 and a slightly high haze.

The present application claims the priority based on Japanese Patent Application No. 2011-263635 filed on Dec. 1, 2011, the entire contents of which including the specification and drawings are incorporated herein by reference.

### INDUSTRIAL APPLICABILITY

The present invention can provide a method for producing an optical film having a low haze by limiting the formation of gel and coloring.

### REFERENCE SIGNS LIST

10 film forming apparatus
12 extruder
14 die
16, 18, 20 cooling roll
22 peeling roll
24 stretching apparatus
26 winding apparatus
28 filter
30 static mixer
32 elastic touch roll
110 liquid crystal display device
120 liquid crystal cell
140 first polarizing plate
142 first polarizer
144 protective film (F1)
146 protective film (F2)
160 second polarizing plate
162 second polarizer
164 protective film (F3)
166 protective film (F4)
180 backlight

1. A method for producing an optical film comprising:
(1) subjecting methyl methacrylate and a copolymerizable monomer containing acryloyl morpholine to a copolymerization reaction in the presence of a polymerization initiator and a chain transfer agent to afford a (meth)acrylic resin; and
(2) melt-extruding a resin composition containing the obtained (meth)acrylic resin and a cellulose ester resin at a (meth)acrylic resin:cellulose ester resin ratio of 95:5 to 30:70 to afford an optical film,
wherein the (meth)acrylic resin obtained in (1) satisfies the following requirements (a), (b), (c), and (d):
(a) a weight average molecular weight Mw is 2.0×10⁴ to 5.0×10⁵;
(b) a total amount of the residual methyl methacrylate and copolymerizable monomer is 0.05 to 1% by weight;
(c) an amount of the residual polymerization initiator is 0.01 to 0.5% by weight; and
(d) an amount of the residual chain transfer agent is 0.01 to 0.5% by weight.

2. The method for producing an optical film according to claim 1, wherein a proportion of a constitutional unit derived from methyl methacrylate in the obtained (meth)acrylic resin is 50 to 99 mol %; and a proportion of a constitutional unit derived from the copolymerizable monomer containing acryloyl morpholine is 1 to 50 mol %.

3. The method for producing an optical film according to claim 1, wherein the copolymerization reaction is a bulk polymerization reaction.

4. The method for producing an optical film according to claim 1, wherein the cellulose ester resin has a total degree of acyl substitution of 2.0 to 3.0 and a degree of C₃₋₇ acyl substitution of 1.2 to 3.0.

5. The method for producing an optical film according to claim 1, wherein the cellulose ester resin has a weight average molecular weight Mw of 7.5×10⁴ to 3.0×10⁵.

6. An optical film obtained by the method according to claim 1, wherein the optical film has a haze of less than 1.0%.

7. A polarizing plate comprising:
a polarizer; and
the optical film according to claim 6 disposed on at least one surface of the polarizer.

8. A liquid crystal display device comprising:
a liquid crystal cell; and
the polarizing plate according to claim 7 disposed on at least one surface of the liquid crystal cell.
